(19) United States
(12) Patent Application Publication
(10) Pub. No.: US 2010/0114890 A1
(43) Pub. Date: May 6, 2010

(54) System and Method for Discovering Latent Relationships in Data

(75) Inventors: David A. Hagar, Dallas, TX (US); Paul A. Jakubik, Plano, TX (US); Stephen S. Jernigan, Murphy, TX (US)

Correspondence Address: BAKER BOTTS L.L.P., 2001 ROSS AVENUE, SUITE 600, DALLAS, TX, 75201-2980, US

(73) Assignee: PureDiscovery Corporation, Dallas, TX (US)

(21) Appl. No.: 12/263,169

(22) Filed: Oct. 31, 2008

(51) Int. Cl. G06F 17/30

(52) U.S. Cl. 707/737; 707/E17.014; 707/E17.009

(57) ABSTRACT

A computerized method of querying an array of vectors includes receiving a first matrix, partitioning the first matrix into a plurality of subset matrices, and processing each subset matrix with a natural language analysis process to create a plurality of processed subset matrices. The first matrix includes a first plurality of terms and represents one or more data objects to be queried, each subset matrix includes similar vectors from the first matrix, and each processed subset matrix relates terms in each subset matrix to each other.

### TECHNICAL FIELD

This disclosure relates in general to searching of data and more particularly to a system and method for discovering latent relationships in data.

### BACKGROUND

Latent Semantic Analysis (“LSA”) is a modern algorithm that is used in many applications for discovering latent relationships in data. In one such application, LSA is used in the analysis and searching of text documents. Given a set of two or more documents, LSA provides a way to mathematically determine which documents are related to each other, which terms in the documents are related to each other, and how the documents and terms are related to a query. Additionally, LSA may also be used to determine relationships between the documents and a term even if the term does not appear in the document.

LSA utilizes Singular Value Decomposition (“SVD”) to determine relationships in the input data. Given an input matrix representative of the input data, SVD is used to decompose the input matrix into three decomposed matrices. LSA then creates compressed matrices by truncating vectors in the three decomposed matrices into smaller dimensions. Finally, LSA analyzes data in the compressed matrices to determine latent relationships in the input data.

### SUMMARY OF THE DISCLOSURE

According to one embodiment, a computerized method of determining latent relationships in data includes receiving a first matrix, partitioning the first matrix into a plurality of subset matrices, and processing each subset matrix with a natural language analysis process to create a plurality of processed subset matrices. The first matrix includes a first plurality of terms and represents one or more data objects to be queried, each subset matrix includes similar vectors from the first matrix, and each processed subset matrix relates terms in each subset matrix to each other.

According to another embodiment, a computerized method of determining latent relationships in data includes receiving a plurality of subset matrices, receiving a plurality of processed subset matrices that have been processed by a natural language analysis process, selecting a processed subset matrix relating to a query, and processing the subset matrix corresponding to the selected processed subset matrix and the query to produce a result. Each subset matrix includes similar vectors from an array of vectors representing one or more data objects to be queried, each processed subset matrix relates terms in each subset matrix to each other, and the query includes one or more query terms.

Technical advantages of certain embodiments may include discovering latent relationships in data without sampling or discarding portions of the data. This results in increased dependability and trustworthiness of the determined relationships and thus a reduction in user uncertainty. Other advantages may include requiring less memory, time, and processing power to determine latent relationships in increasingly large amounts of data. This results in the ability to analyze and process much larger amounts of input data that is currently computationally feasible.

Other technical advantages will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present disclosure and its advantages, reference is now made to the following description, taken in conjunction with the accompanying drawings, in which:

FIG. 1 is a chart illustrating a method to determine latent relationships in data where particular embodiments of this disclosure may be utilized;

FIG. 2 is a chart illustrating a vector partition method that may be utilized in step 130 of FIG. 1 in accordance with a particular embodiment of the disclosure;

FIG. 3 is a chart illustrating a matrix selection and query method that may be utilized in step 160 of FIG. 1 in accordance with a particular embodiment of the disclosure;

FIG. 4 is a graph showing vectors utilized by matrix selector 330 in FIG. 3 in accordance with a particular embodiment of the disclosure; and

FIG. 5 is a system where particular embodiments of the disclosure may be implemented.

### DETAILED DESCRIPTION OF THE DISCLOSURE

A typical Latent Semantic Analysis (“LSA”) process is capable of accepting and analyzing only a limited amount of input data. This is due to the fact that as the quantity of input data doubles, the size of the compressed matrices generated and utilized by LSA to determine latent relationships quadruples in size. Since the entire compressed matrices must be stored in a computer's memory in order for an LSA algorithm to be used to determine latent relationships, the size of the compressed matrices is limited to the amount of available memory and processing power. As a result, large amounts of memory and processing power are typically required to perform LSA on even a relatively small quantity of input data.

Most typical LSA processes attempt to alleviate the size constraints on input data by implementing a sampling technique. For example, one technique is to sample an input data matrix by retaining every N^{th} vector and discarding the remaining vectors. If, for example, every 10th vector is retained, vectors 1 through 9 are discarded and the resulting reduced input matrix is 10% of the size of the original input matrix.

While a sampling technique may be effective at reducing the size of an input matrix to make an LSA process computationally feasible, valuable data may be discarded from the input matrix. As a result, any latent relationships determined by an LSA process may be inaccurate and misleading.

The teachings of the disclosure recognize that it would be desirable for LSA to be scalable to allow it to handle any size of input data without sampling and without requiring increasingly large amounts of memory, time, or processing power to perform the LSA algorithm. The following describes a system and method of addressing problems associated with typical LSA processes.

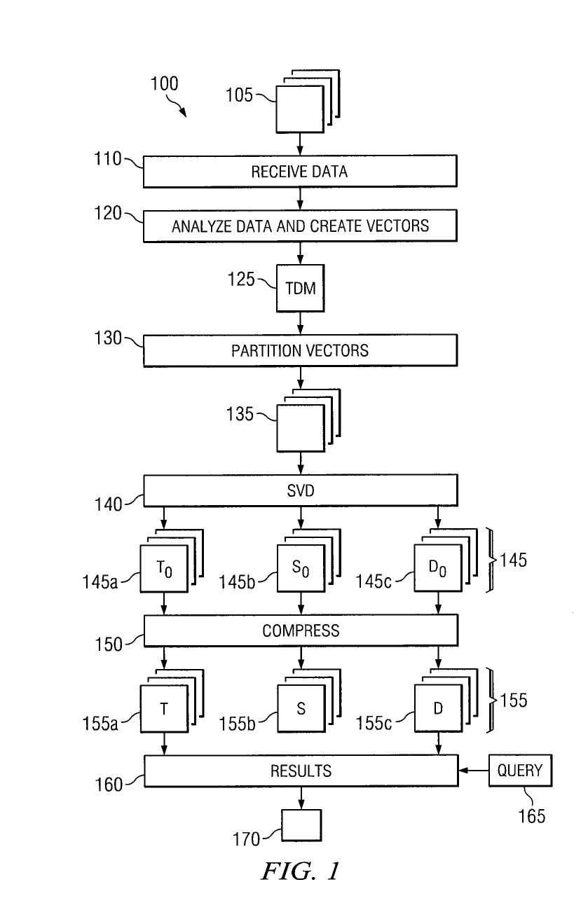

FIG. 1 is schematic diagram depicting a method 100. Method 100 begins in step 110 where one or more data objects 105 to be analyzed are received. Data objects 105 received in step 110 may be any data object that can be represented as a vector. Such objects include, but are not limited to, documents, articles, publications, and the like.

In step 120, received data objects 105 are analyzed and vectors representing data objects 105 are created. In one embodiment, for example, data objects 105 consist of one or more documents and the vectors created from analyzing each document are term vectors. The term vectors contain all of the terms and/or phrases found in a document and the number of occasions the terms and/or phrases appear in the document. The term vectors created from each input document are then combined to create a term-document matrix (“TDM”) 125 which is a matrix having all of the documents on one axis and the terms found in the documents on the other axis. At the intersection of each term and document in TDM 125 is each term's weight multiplied by the number of times the term appears in the document. The term weights may be, for example, standard TFIDF term weights. It should be noted, however, that in addition to the input not being limited to documents, step 120 does not require a specific way of converting data objects 105 into vectors. Any process to convert input data objects 105 into vectors may be utilized if it is used consistently.

In step 130, TDM 125 is received and partitioned into two or more partitioned matrices 135. The size of TDM 125 is directly proportional to the amount of input data objects 105. Consequently, for large amounts of input data objects 105, TDM 125 may be an unreasonable size for typical LSA processes to accommodate. By partitioning TDM 125 into two or more partitioned matrices 135 and then selecting one of partitioned matrices 135 to use for LSA, LSA becomes computationally feasible for any amount of input data objects 105 on even moderately equipped computer systems.

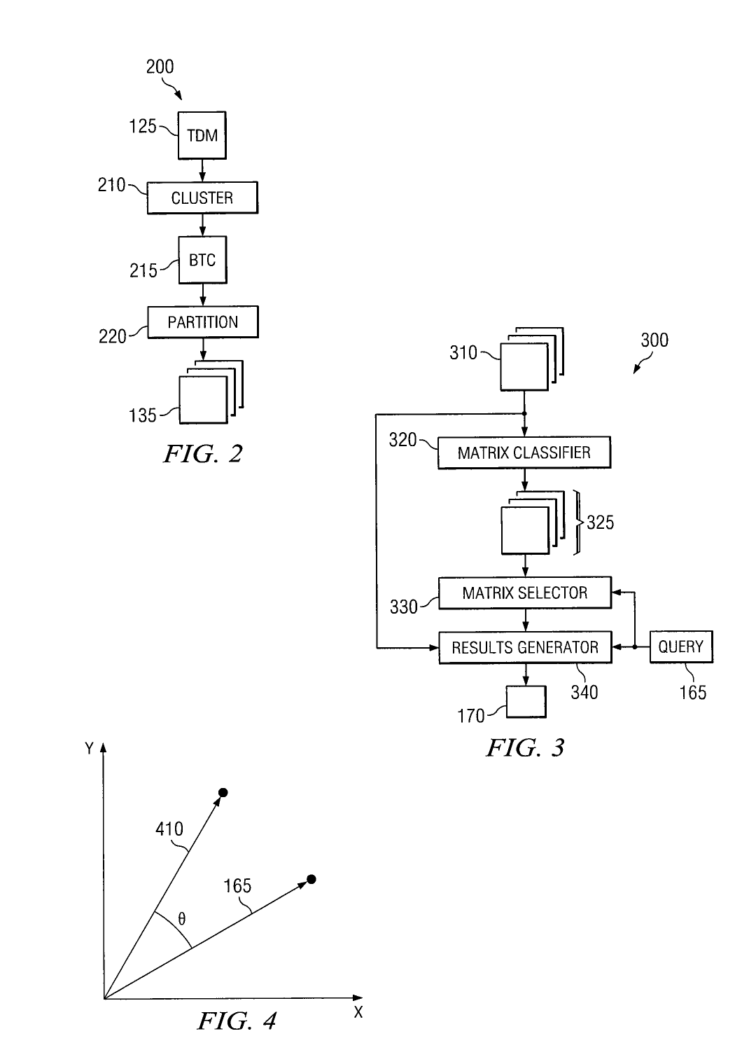

Step 130 may utilize any technique to partition TDM 125 into two or more partitioned matrices 135 that maximizes the similarity between the data in each partitioned matrix 135. In one particular embodiment, for example, step 130 may utilize a clustering technique to partition TDM 125 according to topics. FIG. 2 and its description below illustrate in more detail another particular embodiment of a method to partition TDM 125.

In some embodiments, step 120 may additionally divide large input data objects 105 into smaller objects. For example, if input data objects 105 are text documents, step 120 may utilize a process to divide the text documents into “shingles”. Shingles are fixed-length segments of text that have around 50% overlap with the next shingle. By dividing large text documents into shingles, step 120 creates fixed-length documents which aides LSA and allows vocabulary that is frequent in just one document to be analyzed.

In step 140, method 100 utilizes Singular Value Decomposition (“SVD”) to decompose each partitioned matrix 135 created in step 130 into three decomposed matrices 145: a T₀ matrix 145(a), an S₀ matrix 145(b), and a D₀ matrix 145(c). If data objects 105 received in step 110 are documents, T₀ matrices 145(a) give a mapping of each term in the documents into some higher dimensional space, S₀ matrices 145(b) are diagonal matrices that scale the term vectors in T₀ matrices 145(a), and D₀ matrices 145(c) provide a mapping of each document into a similar higher dimensional space.

In step 150, method 100 compresses decomposed matrices 145 into compressed matrices 155. Compressed matrices 155 may include a T matrix 155(a), an S matrix 155(b), and a D matrix 155(c) that are created by truncating vectors in each T₀ matrix 145(a), S₀ matrix 145(b), and D₀ matrix 145(c), respectively, into K dimensions. K is normally a small number such as 100 or 200. T matrix 155(a), S matrix 155(b), and D matrix 155(c) are well known in the LSA field.

In some embodiments, step 150 may be eliminated and T matrix 155(a), S matrix 155(b), and D matrix 155(c) may be generated in step 140. In such embodiments, step 140 zeroes out portions of T₀ matrix 145(a), S₀ matrix 145(b), and D₀ matrix 145(c) to create T matrix 155(a), S matrix 155(b), and D matrix 155(c), respectively. This is a form of lossy compression that is well-known in the art.

In step 160, T matrix 155(a) and D matrix 155(c) are examined along with a query 165 to determine latent relationships in input data objects 105 and generate a results list 170 that includes a plurality of result terms and a corresponding weight of each result term to the query. For example, if input data objects 105 are documents, a particular T matrix 155(a) may be examined to determine how closely the terms in the documents are related to query 165. Additionally or alternatively, a particular D matrix 155(c) may be examined to determine how closely the documents are related to query 165.

Step 160, along with step 130 above, address the problems associated with typical LSA processes discussed above and may include the methods described below in reference to FIGS. 2 through 5. FIG. 2 and its description below illustrate an embodiment of a method that may be implemented in step 130 to partition TDM 125, and FIG. 3 and its description below illustrate an embodiment of a method to select an optimal compressed matrix 155 to use along with query 165 to produce results list 170.

FIG. 2 illustrates a matrix partition method 200 that may be utilized by method 100 as discussed above to partition TDM 125. According to the teachings of the disclosure, matrix partition method 200 may be implemented in step 130 of method 100 in order to partition TDM 125 into partitioned matrices 135 and thus make LSA computationally feasible for any amount of input data objects 105. Matrix partition method 200 includes a cluster step 210 and a partition step 220.

Matrix partition method 200 begins in cluster step 210 where similar vectors in TDM 125 are clustered together and a binary tree of clusters (“BTC”) 215 is created. Many techniques may be used to create BTC 215 including, but not limited to, iterative k-means++. Once BTC 215 is created, partition step 220 walks through BTC 215 and creates partitioned matrices 135 so that each vector of TDM 125 appears in exactly one partitioned matrix 135, and each partitioned matrix 135 is of a sufficient size to be usefully processed by LSA.

In some embodiments, cluster step 210 may offer an additional improvement to typical LSA processes by removing near-duplicate vectors from TDM 125 prior to partition step 220. Near-duplicate vectors in TDM 125 introduce a strong bias to an LSA analysis and may contribute to wrong conclusions. By removing near-duplicate vectors, results are more reliable and confidence may be increased. To remove near-duplicate vectors from TDM 125, cluster step 210 first finds clusters of small groups of similar vectors in TDM 125 and then compares the vectors in the small groups with each other to see if there are any near-duplicates that may be discarded. Possible clustering techniques include canopy clustering, iterative binary k-means clustering, or any technique to find small groups of N similar vectors, where N is a small number such as 100-1000. In one embodiment, for example, an iterative k-means++ process is used to create a binary tree of clusters with the root cluster containing the vectors of TDM 125, and each leaf cluster containing around 100 vectors. This iterative k-means++ process will stop splitting if the process detects that a particular cluster is mostly near duplicates. As a result, near-duplicate vectors are eliminated from TDM 125 prior to partitioning of TDM 125 into partitioned matrices 135 by partition step 220, and any subsequent results are more reliable and accurate.

Some embodiments that utilize a process to remove near-duplicate vectors such as that described above may also utilize a word statistics process on TDM 125 to regenerate term vectors after near-duplicate vectors are removed from TDM 125 but before partition step 220. Near-duplicate vectors may have a strong influence on the vocabulary of TDM 125. In particular, if phrases are used as terms, a large number of near duplicates will produce a large number of frequent phrases that otherwise would not be in the vocabulary of TDM 125. By utilizing a word statistics process on TDM 125 to regenerate term vectors after near-duplicate vectors are removed, the negative influence of near-duplicate vectors in TDM 125 is removed. As a result, subsequent results generated from TDM 125 are further improved.

By utilizing cluster step 210 and partition step 220, matrix partition method 200 provides method 100 an effective way to handle large quantities of input data without requiring large amounts of computing resources. While typical LSA methods attempt to make LSA computationally feasible by random sampling and throwing away information from input data objects 105, method 100 avoids this by utilizing matrix partition method 200 to partition large vector sets into many smaller partitioned matrices 135. FIG. 3 below illustrates an embodiment to select one of the smaller partitioned matrices 135 that has been processed by method 100 in order to perform a query and produce results list 170.

FIG. 3 illustrates a matrix selection and query method 300 that may be utilized by method 100 as discussed above to efficiently and effectively discover latent relationships in data. According to the teachings of the disclosure, matrix partition method 200 may be implemented, for example, in step 160 of method 100 in order to classify and select an input matrix 310, perform a query on the selected matrix, and output results list 170. Matrix selection and query method 300 includes a matrix classifier 320, a matrix selector 330, and a results generator 340.

Matrix selection and query method 300 begins with matrix classifier 320 receiving two or more input matrices 310. Input matrices 310 may include, for example, T matrices 155(a) and/or D matrices 155(c) that were generated from partitioned matrices 135 as described above. Matrix classifier 320 classifies each input matrix 310 by first creating a TFIDF weighted vector for each vector in input matrix 310. For example, if input matrix 310 is a T matrix 155(a), matrix classifier 320 creates a TFIDF weighted term vector for each document in T matrix 155(a). Matrix classifier 320 then averages all of the weighted vectors in input matrix 310 together to create an average weighted vector 325. Matrix classifier 320 creates an average weighted vector 325 according to this process for each input matrix 310 and transmits the plurality of average weighted vectors 325 to matrix selector 330.

Matrix selector 330 receives average weighted vectors 325 and query 165. Matrix selector 330 next calculates the cosine distance from each average weighted vector 325 to query 165. For example, FIG. 4 graphically illustrates a first average weighted term vector 410 and query 165. Matrix selector 330 calculates the cosine distance between first average weighted term vector 410 and query 165 by calculating the cosine of angle θ (cosine distance) according to equation (1) below:

$$similarity = cos ( θ ) = \frac{( vector 410 ) \cdot ( query 165 )}{‖ vector 410 ‖ ‖ query 165 ‖} \qquad ( 1 )$$

where the cosine distance between two vectors indicates the similarity between the two vectors, with a higher cosine distance indicating a greater similarity. The numerator of equation (1) is the dot product of first average weighted term vector 410 and query 165, and the denominator is the magnitudes of first average weighted term vector 410 and query 165. Once matrix selector 330 computes the cosine distance from every average weighted vector 325 to query 165 according to equation (1) above, matrix selector 330 selects the average weighted vector 325 with the highest cosine distance to query 165 (i.e., the average weighted vector 325 that is most similar to query 165.)

Once the average weighted vector 325 that is most similar to query 165 has been selected by matrix selector 330, the selection is transmitted to results generator 340. Results generator 340 in turn selects input matrix 310 corresponding to the selected average weighted vector 325 and uses the selected input matrix 310 and query 165 to generate results list 170. If, for example, the selected input matrix 310 is a T matrix 155(a), results list 170 will contain terms from T matrix 155(a) and the cosine distance of each term to query 165.

In some embodiments, matrix selector 330 may utilize an additional or alternative method of selecting an input matrix 310 when query 165 contains more than one query word (i.e., a query phrase). In these embodiments, matrix selector 330 first counts the number of query words and phrases from query 165 that actually appear in each input matrix 310. Matrix selector 330 then selects the input matrix 310 that contains the highest count of query words and phrases. Additionally or alternatively, if more than one input matrix 310 contains the same count of query words and phrases, the cosine distance described above in reference to Equation (1) may be used as a secondary ranking criteria. Once a particular input matrix 310 is selected, it is transmitted to results generator 340 where results list 170 is generated.

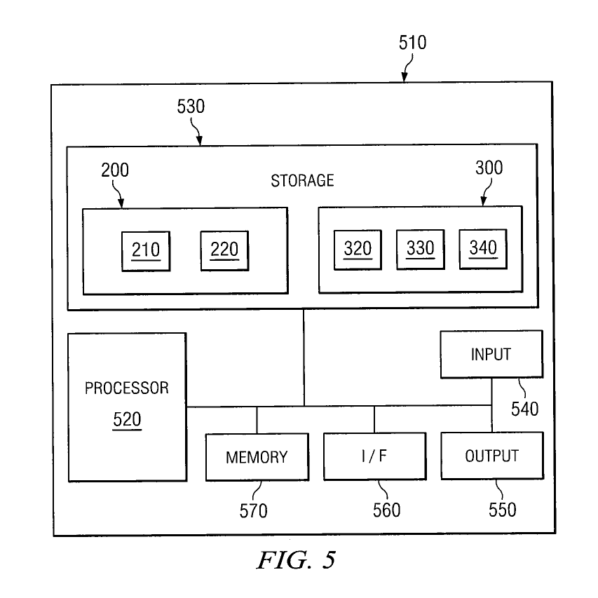

Vector partition method 210, matrix selection and query method 300, and the various other methods described herein may be implemented in many ways including, but not limited to, software stored on a computer-readable medium. FIG. 5 below illustrates an embodiment where the methods described in FIGS. 1 through 4 may be implemented.

FIG. 5 is block diagram illustrating a portion of a system 510 that may be used to discover latent relationships in data according to one embodiment. System 510 includes a processor 520, a storage device 530, an input device 540, an output device 550, communication interface 560, and a memory device 570. The components 520-570 of system 510 may be coupled to each other in any suitable manner. In the illustrated embodiment, the components 520-570 of system 510 are coupled to each other by a bus.

Processor 520 generally refers to any suitable device capable of executing instructions and manipulating data to perform operations for system 510. For example, processor 520 may include any type of central processing unit (CPU). Input device 540 may refer to any suitable device capable of inputting, selecting, and/or manipulating various data and information. For example, input device 540 may include a keyboard, mouse, graphics tablet, joystick, light pen, microphone, scanner, or other suitable input device. Memory device 570 may refer to any suitable device capable of storing and facilitating retrieval of data. For example, memory device 570 may include random access memory (RAM), read only memory (ROM), a magnetic disk, a disk drive, a compact disk (CD) drive, a digital video disk (DVD) drive, removable media storage, or any other suitable data storage medium, including combinations thereof.

Communication interface 560 may refer to any suitable device capable of receiving input for system 510, sending output from system 510, performing suitable processing of the input or output or both, communicating to other devices, or any combination of the preceding. For example, communication interface 560 may include appropriate hardware (e.g., modem, network interface card, etc.) and software, including protocol conversion and data processing capabilities, to communicate through a LAN, WAN, or other communication system that allows system 510 to communicate to other devices. Communication interface 560 may include one or more ports, conversion software, or both. Output device 550 may refer to any suitable device capable of displaying information to a user. For example, output device 550 may include a video/graphical display, a printer, a plotter, or other suitable output device.

Storage device 530 may refer to any suitable device capable of storing computer-readable data and instructions. Storage device 530 may include, for example, logic in the form of software applications, computer memory (e.g., Random Access Memory (RAM) or Read Only Memory (ROM)), mass storage media (e.g., a magnetic drive, a disk drive, or optical disk), removable storage media (e.g., a Compact Disk (CD), a Digital Video Disk (DVD), or flash memory), a database and/or network storage (e.g., a server), other computer-readable medium, or a combination and/or multiples of any of the preceding. In this example, vector partition method 210, matrix selection and query method 300, and their respective components embodied as logic within storage 530 generally provide improvements to typical LSA processes as described above. However, vector partition method 210 and matrix selection and query method 300 may alternatively reside within any of a variety of other suitable computer-readable medium, including, for example, memory device 570, removable storage media (e.g., a Compact Disk (CD), a Digital Video Disk (DVD), or flash memory), any combination of the preceding, or some other computer-readable medium.

The components of system 510 may be integrated or separated. In some embodiments, components 520-570 may each be housed within a single chassis. The operations of system 510 may be performed by more, fewer, or other components. Additionally, operations of system 510 may be performed using any suitable logic that may comprise software, hardware, other logic, or any suitable combination of the preceding.

Although the embodiments in the disclosure have been described in detail, numerous changes, substitutions, variations, alterations, and modifications may be ascertained by those skilled in the art. It is intended that the present disclosure encompass all such changes, substitutions, variations, alterations and modifications as falling within the spirit and scope of the appended claims.

What is claimed is:

1. A computerized method of determining latent relationships in data comprising:
receiving a first matrix comprising a first plurality of terms, the first matrix representing one or more data objects to be queried;
partitioning the first matrix into a plurality of subset matrices, each subset matrix comprising similar vectors from the first matrix; and
processing each subset matrix with a natural language analysis process to create a plurality of processed subset matrices, each processed subset matrix relating terms in each subset matrix to each other.

2. The computerized method of determining latent relationships in data of claim 1, wherein the partitioning the first matrix into a plurality of subset matrices comprises:
clustering similar vectors in the first matrix together; and
forming each of the subset matrices so that each vector in the first matrix appears in exactly one subset matrix, the size of each subset matrix being a size that may be usefully processed by the natural language analysis process.

3. The computerized method of determining latent relationships in data of claim 1, wherein vectors are not discarded from the first matrix prior to partitioning the first matrix into a plurality of subset matrices.

4. The computerized method of determining latent relationships in data of claim 1, wherein the natural language analysis process comprises Latent Semantic Analysis and the processing each subset matrix to create a plurality of processed subset matrices comprises processing the plurality of subset matrices with Singular Value Decomposition to produce the plurality of processed subset matrices.

5. The computerized method of determining latent relationships in data of claim 1 further comprising removing near duplicate vectors from the first matrix before partitioning the first matrix into a plurality of subset matrices.

6. The computerized method of determining latent relationships in data of claim 1 further comprising:
analyzing one or more documents and identifying the first plurality of terms from the one or more documents; and
creating the first matrix comprising the first plurality of terms, the one or more documents, and a product of the weight of each term and a count of occurrences of each term in the one or more documents.

7. The computerized method of determining latent relationships in data of claim 1 further comprising:
selecting a processed subset matrix relating to a query; and
processing the subset matrix corresponding to the selected processed subset matrix and the query to produce a result.

8. The computerized method of determining latent relationships in data of claim 7, wherein the selecting a processed subset matrix relating to a query comprises:
creating a plurality of averaged weighted vectors from the plurality of processed subset matrices;
calculating a cosine distance from each average weighted vector to the query;
selecting the averaged weighted vector with the highest cosine distance to the query; and
selecting the processed subset matrix corresponding to the selected averaged weighted vector.

9. The computerized method of determining latent relationships in data of claim 7, wherein selection of the processed subset matrix relating to a query comprises selecting the processed subset matrix by a process selected from the group consisting of naive Bayes classifiers, TFIDF, latent semantic indexing, support vector machines, artificial neural networks, kNN, decisions tress, and concept mining.

10. The computerized method of determining latent relationships in data of claim 6 further comprising dividing the one or more documents into a plurality of shingles prior to analyzing the one or more documents.

11. A computerized method of determining latent relationships in data comprising:
receiving a plurality of subset matrices, each subset matrix comprising similar vectors from an array of vectors representing one or more data objects to be queried;
receiving a plurality of processed subset matrices that have been processed by a natural language analysis process, each processed subset matrix relating terms in each subset matrix to each other;
selecting a processed subset matrix relating to a query, the query comprising one or more query terms; and
processing the subset matrix corresponding to the selected processed subset matrix and the query to produce a result.

12. The computerized method of determining latent relationships in data of claim 11, wherein the selecting a processed subset matrix relating to a query comprises:
creating a plurality of averaged weighted vectors from the plurality of processed subset matrices;
calculating a cosine distance from each average weighted vector to the query;
selecting the averaged weighted vector with the highest cosine distance to the query; and
selecting the processed subset matrix corresponding to the selected averaged weighted vector.

13. The computerized method of determining latent relationships in data of claim 11, wherein selection of the processed subset matrix relating to a query comprises selecting the processed subset matrix by a process selected from the group consisting of naive Bayes classifiers, TFIDF, latent semantic indexing, support vector machines, artificial neural networks, kNN, decisions tress, and concept mining.

14. The computerized method of determining latent relationships in data of claim 11, wherein the natural language analysis process comprises a Latent Semantic Analysis process, the Latent Semantic Analysis process further comprising processing the plurality of subset matrices with Singular Value Decomposition to produce the plurality of processed subset matrices.

15. The computerized method of determining latent relationships in data of claim 11 further comprising:
analyzing one or more documents and identifying a first plurality of terms from the one or more documents;
creating the first matrix comprising the first plurality of terms, the one or more documents, and a product of the weight of each term and a count of occurrences of each term in the one or more documents;
partitioning the first matrix into a plurality of subset matrices; and
processing each subset matrix with the natural language analysis process to create the plurality of processed subset matrices.

16. The computerized method of determining latent relationships in data of claim 15, wherein the partitioning the first matrix into a plurality of subset matrices comprises:
clustering similar vectors in the first matrix together; and
forming each of the subset matrices so that each vector in the first matrix appears in exactly one subset matrix, the size of each subset matrix being a size that may be usefully processed by the natural language analysis process.

17. The computerized method of determining latent relationships in data of claim 15, wherein vectors are not discarded from the first matrix prior to partitioning the first matrix into a plurality of subset matrices.

18. The computerized method of determining latent relationships in data of claim 15 further comprising removing near duplicate vectors from the first matrix before partitioning the first matrix into a plurality of subset matrices.

19. The computerized method of determining latent relationships in data of claim 11, wherein the selecting a processed subset matrix relating to a query comprises:
identifying the number of times the one or more query terms appear in each processed subset matrix; and
selecting the processed subset matrix that contains the greatest number of query terms.

20. The computerized method of determining latent relationships in data of claim 19 further comprising:
creating a plurality of averaged weighted vectors from the plurality of processed subset matrices;
calculating a cosine distance from each average weighted vector to the query; and
selecting the averaged weighted vector with the highest cosine distance to the query when more than one processed subset matrix contains the greatest number of query terms.

21. The computerized method of determining latent relationships in data of claim 15 further comprising dividing the one or more documents into a plurality of shingles prior to analyzing the one or more documents.

22. Computer-readable media having logic stored therein, the logic operable, when executed on a processor, to:
receive a first matrix comprising a first plurality of terms, the first matrix representing one or more data objects to be queried;
partition the first matrix into a plurality of subset matrices, each subset matrix comprising similar vectors from the first matrix; and
process each subset matrix with a natural language analysis process to create a plurality of processed subset matrices, each processed subset matrix relating terms in each subset matrix to each other.

23. The computer-readable media of claim 22, wherein the partition the first matrix into a plurality of subset matrices comprises:
clustering similar vectors in the first matrix together; and
forming each of the subset matrices so that each vector in the first matrix appears in exactly one subset matrix, the size of each subset matrix being a size that may be usefully processed by the natural language analysis process.

24. The computer-readable media of claim 22, wherein vectors are not discarded from the first matrix prior to partitioning the first matrix into a plurality of subset matrices.

25. The computer-readable media of claim 22, wherein the natural language analysis process comprises Latent Semantic Analysis and the process each subset matrix to create a plurality of processed subset matrices comprises processing the plurality of subset matrices with Singular Value Decomposition to produce the plurality of processed subset matrices.

26. The computer-readable media of claim 22, the logic further operable to remove near duplicate vectors from the first matrix before partitioning the first matrix into a plurality of subset matrices.

27. The computer-readable media of claim 22, the logic further operable to:
analyze one or more documents and identify the first plurality of terms from the one or more documents; and
create the first matrix comprising the first plurality of terms, the one or more documents, and a product of the weight of each term and a count of occurrences of each term in the one or more documents.

28. The computer-readable media of claim 22, the logic further operable to:
select a processed subset matrix relating to a query; and
process the subset matrix corresponding to the selected processed subset matrix and the query to produce a result.

29. The computer-readable media of claim 28, wherein the select a processed subset matrix relating to a query comprises:
creating a plurality of averaged weighted vectors from the plurality of processed subset matrices;
calculating a cosine distance from each average weighted vector to the query;
selecting the averaged weighted vector with the highest cosine distance to the query; and
selecting the processed subset matrix corresponding to the selected averaged weighted vector.

30. The computer-readable media of claim 28, wherein selection of the processed subset matrix relating to a query comprises selecting the processed subset matrix by a process selected from the group consisting of naive Bayes classifiers, TFIDF, latent semantic indexing, support vector machines, artificial neural networks, kNN, decisions tress, and concept mining.

31. The computer-readable media of claim 27, the logic further operable to divide the one or more documents into a plurality of shingles prior to analyzing the one or more documents.

32. Computer-readable media having logic stored therein, the logic operable, when executed on a processor, to:
receive a plurality of subset matrices, each subset matrix comprising similar vectors from an array of vectors representing one or more data objects to be queried;
receive a plurality of processed subset matrices that have been processed by a natural language analysis process, each processed subset matrix relating terms in each subset matrix to each other;
select a processed subset matrix relating to a query, the query comprising one or more query terms; and
process the subset matrix corresponding to the selected processed subset matrix and the query to produce a result.

33. The computer-readable media of claim 32, wherein the select a processed subset matrix relating to a query comprises:
creating a plurality of averaged weighted vectors from the plurality of processed subset matrices;
calculating a cosine distance from each average weighted vector to the query;
selecting the averaged weighted vector with the highest cosine distance to the query; and
selecting the processed subset matrix corresponding to the selected averaged weighted vector.

34. The computer-readable media of claim 32, wherein selection of the processed subset matrix relating to a query comprises selecting the processed subset matrix by a process selected from the group consisting of naive Bayes classifiers, TFIDF, latent semantic indexing, support vector machines, artificial neural networks, kNN, decisions tress, and concept mining.

35. The computer-readable media of claim 32, wherein the natural language analysis process comprises a Latent Semantic Analysis process, the Latent Semantic Analysis process further comprising processing the plurality of subset matrices with Singular Value Decomposition to produce the plurality of processed subset matrices.

36. The computer-readable media of claim 32, the logic further operable to:
analyze one or more documents and identify a first plurality of terms from the one or more documents;
create the first matrix comprising the first plurality of terms, the one or more documents, and a product of the weight of each term and a count of occurrences of each term in the one or more documents;
partition the first matrix into a plurality of subset matrices; and
process each subset matrix with the natural language analysis process to create the plurality of processed subset matrices.

37. The computer-readable media of claim 36, wherein the partition the first matrix into a plurality of subset matrices comprises:
clustering similar vectors in the first matrix together; and
forming each of the subset matrices so that each vector in the first matrix appears in exactly one subset matrix, the size of each subset matrix being a size that may be usefully processed by the natural language analysis process.

38. The computer-readable media of claim 36, wherein vectors are not discarded from the first matrix prior to partitioning the first matrix into a plurality of subset matrices.

39. The computer-readable media of claim 36, the logic further operable to remove near duplicate vectors from the first matrix before partitioning the first matrix into a plurality of subset matrices.

40. The computer-readable media of claim 32, wherein the select a processed subset matrix relating to a query comprises:
identifying the number of times the one or more query terms appear in each processed subset matrix; and
selecting the processed subset matrix that contains the greatest number of query terms.

41. The computer-readable media of claim 40 further comprising:
creating a plurality of averaged weighted vectors from the plurality of processed subset matrices;
calculating a cosine distance from each average weighted vector to the query; and
selecting the averaged weighted vector with the highest cosine distance to the query when more than one processed subset matrix contains the greatest number of query terms.

42. The computer-readable media of claim 36, the logic further operable to divide the one or more documents into a plurality of shingles prior to analyzing the one or more documents.
